(19) United States
(12) Patent Application Publication
(10) Pub. No.: US 2025/0198936 A1
(43) Pub. Date: Jun. 19, 2025

(54) POLLUTION DETECTION PATCH

(71) Applicant: L'Oreal, Paris (FR)

(72) Inventors: Ritesh SINHA, Linden, NJ (US); Xuefei LIU, Edison, NJ (US); Hy Si Bui, Piscataway, NJ (US)

(73) Assignee: L'Oreal, Paris (FR)

(21) Appl. No.: 18/543,501

(22) Filed: Dec. 18, 2023

(51) Int. Cl. G01N 21/78

(52) U.S. Cl. CPC G01N 21/78

(57) ABSTRACT

Articles, kits, and methods for determining and measuring exposure to environmental particulate matter. A pollution detection patch implements a polymer that becomes darkened or discolored as a result of adherence of airborne particulate matter to the polymer, as well as a discoloration reference for optical or visual correspondence of the degree of discoloration of the polymer with a known level of exposure to environmental particulate matter associated with the discoloration reference. The pollution detection patch can be used as a standalone article to monitor exposure or can be incorporated into other articles, products, devices, or environments for low-maintenance monitoring of environmental particulate matter exposure.

### SUMMARY

In an aspect, the disclosure provides an article for determination of exposure to airborne particulate matter, the article comprising: a polymer configured to adsorb airborne particulates thereon, wherein adsorption of airborne particulates to the polymer causes the polymer to become a discolored polymer; and a discoloration reference configured for an optical comparison with the discolored polymer, wherein the optical comparison enables determination of whether the article has airborne particulate matter exposure.

In embodiments, the discoloration reference optically corresponds to the discolored polymer, such that a visual appearance of the discoloration reference at least partially matches a visual appearance of the discolored polymer for determination of whether the article has airborne particulate matter exposure.

In embodiments, the polymer is hydrophobic.

In embodiments, the discoloration reference is movably attached to a portion of the article that comprises the polymer on at least a portion thereof, such that movement of the discoloration reference closer to or relative to the polymer facilitates the optical comparison.

In embodiments, the discoloration reference is rotatably attached to a portion of the article that comprises the polymer on at least a portion thereof, such that rotational movement of the discoloration reference closer to or relative to the polymer facilitates the optical comparison.

In embodiments, the discoloration reference comprises an aperture thereon, such that a portion of a surface positioned underneath the aperture appears adjacent to the discoloration reference for the optical comparison between the discoloration reference and the discolored polymer.

In embodiments, the article comprises a plurality of discoloration references along a gradient and each discoloration reference corresponds to a degree of discoloration of the discolored polymer.

In embodiments, the article further comprises an attachment portion configured for attachment of the article to a surface.

In embodiments, the attachment portion is a lower layer of the article, the polymer is at least part of an intermediate layer of the article, and the discoloration reference is an upper layer of the article.

In an aspect, the disclosure provides an article for measurement of exposure to airborne particulate matter, the article comprising: a polymer configured to adsorb airborne particulates thereon, wherein adsorption of airborne particulates to the polymer causes the polymer to become a discolored polymer that is discolored with a degree of discoloration; and a plurality of discoloration references along a gradient configured for an optical comparison with the discolored polymer, wherein the optical comparison correlates a particular discoloration reference of the gradient with the degree of discoloration of the discolored polymer for measurement of exposure of the article to airborne particulate matter.

In embodiments, each discoloration reference corresponds to a level of exposure to airborne particulate matter that is based at least in part on an airborne concentration of particulate matter in an environment.

In embodiments, the plurality of discoloration references are arranged adjacent to each other in an arrangement with the gradient increasing along the arrangement.

In embodiments, the article is circular, the arrangement of the plurality of discoloration references is a semi-circle, and each discoloration reference is a circle sector of the semi-circle.

In embodiments, each discoloration reference comprises an aperture thereon, such that a portion of a surface positioned underneath the aperture appears adjacent to the particular discoloration reference for the optical comparison between the particular discoloration reference and the degree of discoloration of the discolored polymer.

In embodiments, the semi-circle arrangement of the plurality of discoloration references is rotatably attached to a portion of the article that comprises the polymer on at least a portion thereof, such that rotational movement of the semi-circle arrangement of the plurality of discoloration references closer to or relative to the polymer facilitates the optical comparison.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 shows an exploded perspective view of an example pollution detection patch, according to the disclosure.

FIG. 2 shows a top view of the example pollution detection patch, unexposed to particulate pollution.

FIG. 3 shows a top view of the example pollution detection patch, after being exposed to a degree of particulate pollution such that a polymer of the patch is discolored.

FIG. 4 shows a top view of the example pollution detection patch, after being exposed to particulate pollution, with a discoloration reference configured for an optical comparison rotated for comparison with the discolored polymer.

FIG. 5 shows a flowchart of steps of an example method for mitigating risk due to exposure to particulate matter using an example pollution detection patch according to the disclosure.

The foregoing aspects and many of the attendant advantages of this disclosure will become more readily appreciated as the same become better understood by reference to the following detailed description, when taken in conjunction with the accompanying drawings.

### DETAILED DESCRIPTION

Particulate pollution or particulate matter (PM) is comprised of particles of solids and/or liquids that are in the air. Examples include dust, dirt, soot, smoke, and drops of liquid. This type of pollution can come from primary sources that form particles on their own, such as wood stoves and forest fires, as well as secondary sources that emit gases that in turn form particles, such as power plants, coal fires, factories, vehicles, and the like. Oftentimes, these emissions contain PM as fine particles (e.g., PM_{2.5}) and/or coarse particles (e.g., PM₁₀). Fine particles (e.g., PM_{2.5}) can be considered particularly dangerous to health since they can penetrate the skin, lungs, blood, and/or other organs and cause health problems. In particular, exposure to PM_{2.5} has been associated with ischemic heart disease, stroke, COPD, diabetes mellitus, and lung cancer (Sang, S. et al. The global burden of disease attributable to ambient fine particulate matter in 204 countries and territories, 1990-2019: A systematic analysis of the Global Burden of Disease Study 2019. Ecotoxicol Environ Saf. 2022 Jun. 15; 238:113588.).

Typical devices for monitoring PM are complex and involve extensive dedicated electronic features for analysis. There is a need for devices that require little or no power for operation, that can be reliably implemented in a consumer or industrial setting for PM exposure monitoring over longer timelines. The present disclosure meets these and other long-felt and unmet needs in the art.

### Pollution Detection Patches

In an aspect, the disclosure provides an article, e.g., a pollution detection patch, for determination of exposure to airborne particulate matter. The article can be operable for monitoring exposure to airborne particulate matter without extensive dedicated electronic features. The article can comprise a polymer, e.g., a hydrophobic polymer, that adsorbs airborne particulates thereon, causing a discoloration in the polymer as a result of the adsorption of the particulate matter to the polymer. The article can further comprise a discoloration reference that contains one or more reference values for optically comparing degree of discoloration of the polymer with the reference. This optical comparison enables determination of whether the article has airborne particulate matter exposure, and if so, to what degree.

In embodiments, the article is for a binary determination of whether or not the article is exposed to PM in an environment (i.e., PM exposure TRUE or FALSE). However, in embodiments, the article can be discolored according to a degree of discoloration, and a plurality of discoloration references, e.g., along a gradient, is configured for an optical comparison with the discolored polymer. In such embodiments, the optical comparison correlates a particular discoloration reference of the gradient with the degree of discoloration of the discolored polymer for measurement of exposure of the article to airborne particulate matter.

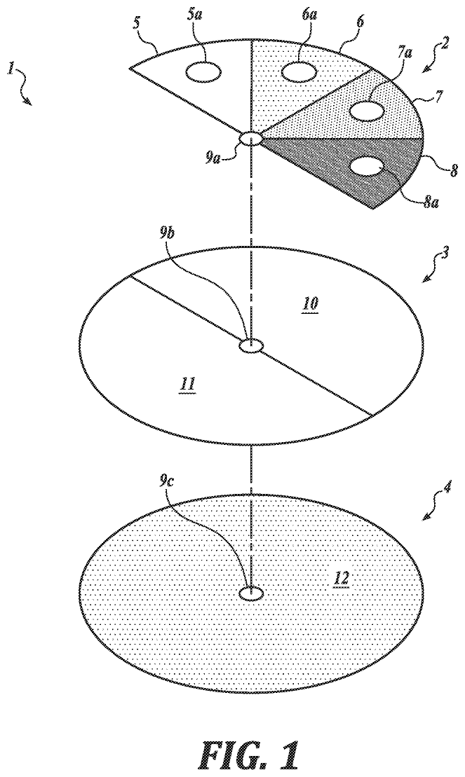

By way of example, at FIG. 1, there is shown an example pollution detection patch, according to the disclosure, in exploded perspective view. In the shown embodiment, a pollution detection patch 1 comprises a plurality of discoloration references 2 (i.e., comprised of individual discoloration references 5, 6, 7, 8) along a gradient, such that each discoloration reference corresponds to a degree of discoloration of the discolored polymer. For example, reference 5 corresponds to zero or negligible PM exposure; reference 6 corresponds to light exposure; reference 7 corresponds to intermediate exposure; and reference 8 corresponds to heavy exposure. The shade of the reference increases in opacity or darkness with higher corresponding levels of exposure. In the shown embodiment, article 1 is circular, and the arrangement of the plurality of discoloration references 2 is a semi-circle, and each discoloration reference (5, 6, 7, 8) is a circle sector of the semi-circle. However, other article shapes and other arrangements of the plurality of discoloration references 2 can be implemented, according to embodiments. In embodiments, the plurality of discoloration references 2 can be laminated with a transparent polymer film or glass, for example.

In the shown embodiment, the plurality of discoloration references 2 is disposed on a semi-circular piece of suitable material, such as a fabric, a paper, a polymer, a plastic, a wood, a metal, or any combination thereof, or another suitable material; however, other shapes and/or materials can be implemented, in embodiments. In the shown embodiment, the plurality of discoloration references 2 is arranged such that references are adjacent to each other in an arrangement with the gradient increasing along the arrangement, however, the references (5, 6, 7, 8) can be arranged in any arrangement. In the shown embodiment, each reference (5, 6, 7, 8) contains an aperture (5a, 6a, 7a, 8a) therethrough, such that surfaces positioned underneath the aperture are visible when viewed from above the article, as explained elsewhere herein. In this manner, the references (5, 6, 7, 8) are more easily visually or optically compared with the polymer for determination of an exposure level.

In the shown embodiment, patch 1 comprises a polymer layer 3, comprised of an inert support 10 and a polymer 11; in embodiments, inert support 10 is coated with a dispersion of a pollutant attractive polymer, as described elsewhere herein. The inert support 10 can be non-reactive with PM, however, the polymer 11 is reactive with PM in the sense that it adsorbs PM thereto, resulting in discoloration of the polymer 11 and functionality of the patch in detecting and/or quantitating airborne PM exposure levels in the environment. In embodiments, polymer 11 is deposited to a half of a circular disk-shaped inert support 10, such that half the inert support 10 does not comprise the polymer thereon, and the other half of the inert support 11 does comprise the polymer thereon. However, in embodiments, more of the inert support 10, e.g., the entire inert support 10, can receive polymer 11 deposited thereto for full coverage of the upper surface of the polymer layer 3 with polymer 11.

In the shown embodiment, article 1 further comprises an attachment portion 4 configured for attachment of the article 1 to a surface. Attachment portion 4 can comprise, for example, an adhesive tape, a magnetic layer for attachment of the patch to metal surfaces such as cars or otherwise, a hook-and-loop attachment, or another structure on a bottom of attachment portion 4. Attachment portion 4 can include an adhesive 12 on a top of attachment portion 4 for securement of the polymer layer 3 thereto.

In embodiments, attachment portion 4 can be configured for hanging article 1 to a surface or other article, or a body of an individual who wears article 1. In instances where an individual wears article 1, article 1 can function as a kind of “dosimeter” for monitoring of the individual's exposure to PM. This wearable “exposome monitor” can monitor individual exposure and serve as an early warning system for potentially harmful exposure levels, enabling the individual to mitigate their exposure to potentially harmful pollution (e.g., “exposome”) by adjusting their location, behavior, or routine, or implementing other protective actions such as applying protective materials, substances, or personal protective equipment (PPE) for protection of the individual from potential health problems due to exposure to PM. In example embodiments, the patch can be used as an indicator for when and/or where respiratory masks and/or eye or other protection should be worn, for example. In embodiments, the patch itself can be used as an indicator as to when and/or where a filter, such as a respiratory mask or other PM filter, becomes worn or clogged and should be maintained, cleaned, or replaced; for example, patch 1 can be attached to or integral with a respiratory mask, such as an N95 respiratory mask, or the like. In addition, in industrial settings, for example, accumulation of airborne PM can be an indicator of an actual or potential equipment failure; in such instances, patch 1 can be used to warn operators of a pending failure or a need for equipment maintenance.

In the shown embodiment, a central hinge is comprised of an upper pin 9a, that extends through polymer pinhole 9b and attachment portion pinhole 9c for securement of the plurality of discoloration references 2 with the polymer layer 3 and the attachment portion 4 to form an assembled state of the article 1 for use. Central hinge (91, 9b, 9c) enables rotation of the plurality of discoloration references 2 relative to the polymer layer 3, as described elsewhere herein, for easier visual comparison of the references (5, 6, 7, 8) with the discoloration of polymer 11.

In embodiments, references of the plurality of discoloration references (5, 6, 7, 8) correspond to qualitative levels of exposure to PM. For example, it can suffice in at least some situations that the level of PM exposure is indicated as “light”, “intermediate”, or “heavy”, as the case may be. However, in other situations, references of the plurality of discoloration references 2 (i.e., 5, 6, 7, 8) correspond to defined, quantitative levels of exposure to PM. An example of a defined level of exposure can include exposure to a particular airborne concentration of PM, optionally for a particular period of time. In embodiments, references of the plurality of discoloration references can be selected or calibrated based on performance of a particular polymer across a range of defined, quantitative levels of exposure to PM. In this manner, the coloration or shade of a given discolored polymer state can be matched with a particular reference for determination of an at least approximate exposure level as indicated by that reference. For example, suppose that reference 6 corresponds to a PM exposure quantitation of X. If the polymer of the article becomes discolored such that it at least approximately resembles reference 6, then it can be stated that a PM exposure quantitation in one or more environments within which the article is placed is at least approximately X. In this manner, the article can be configured for qualitative use and/or quantitative use, and can be used in any of a variety of scenarios, including personal use, industrial use, and others.

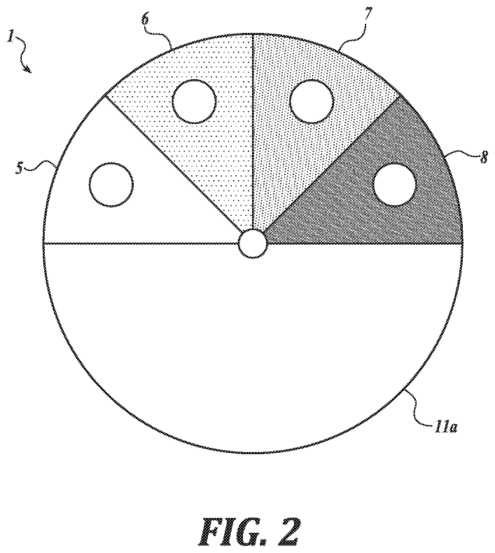

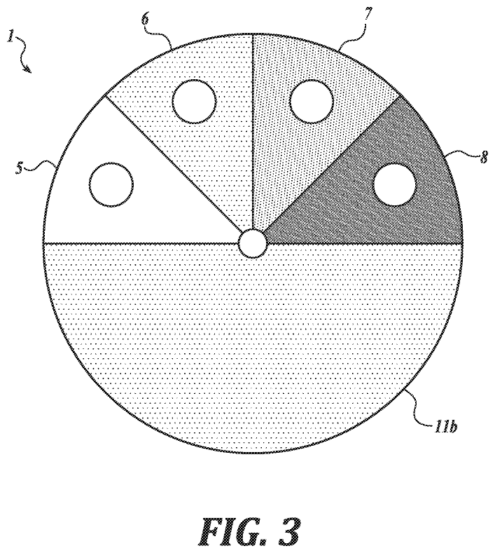

Referring now to FIG. 2, there is shown a top view of the example pollution detection patch 1, in an assembled state and unexposed to particulate pollution. The polymer is in a non-discolored state 11a, and optically corresponds to reference 5, i.e., negative control reference. In the shown embodiment, the non-discolored state 11a of the polymer is bright white. As shown at FIG. 3, after being exposed to a degree of particulate pollution such that a polymer of the patch is discolored, the polymer is in a discolored state 11b. In the shown embodiment, discolored state 11b optically corresponds to reference 6, such that a visual appearance of the discoloration reference 6 at least partially matches a visual appearance of the discolored polymer 11b for determination of whether the article has airborne particulate matter exposure, and if so, to what degree.

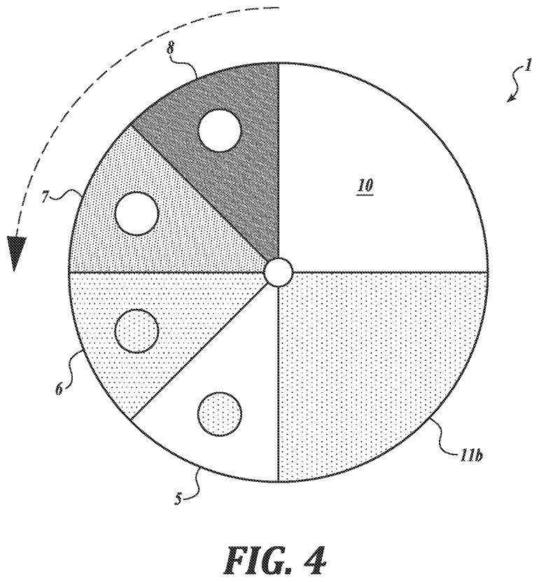

Referring now to FIG. 4, there is shown a top view of the example pollution detection patch 1, after being exposed to particulate pollution, with a discoloration reference 6 configured for an optical comparison moved or rotated for comparison with the discolored polymer 11b. In the shown embodiment, the plurality of discoloration references (5, 6, 7, 8) are rotated 90 degrees such that discoloration reference 6 overlaps with the polymer as the polymer is in the discolored state 11b. In this configuration, the discolored state 11b is visible through the aperture of reference 6, for easier visual comparison of reference 6 with the discolored state 11b. In the shown example, discolored state 11b at least approximately corresponds with reference 6, e.g., based on a grayscale coloration and/or hue, brightness, chromaticity, and/or saturation, for example. The discolored state 11b, and other discolored states of the polymer, can appear as decreases in brightness of the default bright white coloration, for example. The determined exposure can be graduated, for example, as a score from 1 to 10, wherein 1 is lesser exposure and 10 is greater exposure to PM, according to embodiments.

In embodiments, the pollution detection patch can be implemented as, or incorporated into, any form factor according to need. Example form factors include a disposable patch, a reusable patch, a washable patch, a wrist band, a finger ring, a neck ring, or another wearable form factor. In embodiments, the patch can be attached to a vehicle, a house or other structure, equipment monitoring systems, manufacturing or machining systems, and the like.

In embodiments, the polymer used for making the patch is hydrophobic and can attract airborne pollution such as dust, carbon soot, PM_{2.5}, and others. In example embodiments, a polymer produced by MYCELX® can be used as a polymer of a patch or article of the disclosure, however, any suitable polymer or other material can be used according to its effectiveness. Example MYCELX® polymer compositions for making a polymer of a patch or article of the disclosure can include, by way of non-limiting examples, one or more compositions or polymers disclosed in U.S. Pat. No. 5,746,925, one or more compositions or polymers disclosed in U.S. Pat. No. 5,437,793, and/or one or more compositions or polymers disclosed in U.S. Pat. No. 5,698,139, each of which is incorporated by reference herein in its entirety for all purposes.

In embodiments, a polymer composition of the disclosure can be produced by chemically reacting (e.g., crosslinking) linseed oil with isobutyl methacrylate, and the product diluted with a suitable solvent, such as 2,2,4-trimethyl-1,3-pentanediol monoisobutyrate. The composition formed by the thermal reaction of the linseed oil with the isobutyl methacrylate polymer is a soft resinous product which, when diluted with the solvent, results in a mixture that can be sprayed onto a surface, such as inert support 10 of the patch of the disclosure. In embodiments, a polymer of the article of the disclosure can be produced from methacrylate polymers and any of a variety of natural animal and vegetable oils. The oil and the polymer can be reacted in a thermal reaction that does not appear to be sensitive to the atmosphere under which the reaction is carried out, i.e., whether it is an inert, oxidizing or reducing atmosphere. Compositions that have an oil to polymer ratio ranging from about 3:1 to 1:1 can be used, resulting in polymers exhibiting physical properties ranging from soft to hard, and elastomeric to brittle in nature depending upon the ratio of the oil to polymer and the choice of polymer and/or oil used.

In embodiments, a polymer composition can be applied to inert support 10 by reducing the viscosity of the polymer composition and depositing it onto inert support 10, which can be porous, in embodiments. Since the viscosity of MYCELX® polymer compositions at room temperature is very high (e.g., around 700-800 pa*s), in embodiments, a deposition method for depositing a polymer composition onto inert support 10 includes reducing viscosity of a polymer composition by heating, or dissolving in a solution, then depositing the reduced viscosity polymer composition on inert support 10.

As a first example of deposition of a polymer composition onto inert support 10, a first step includes mixing the polymer composition in caprylic/capric triglyceride at any concentration, from 0-100% to produce a polymer composition mixture; a second step includes submerging the patch (e.g., inert support 10, which can comprise cellulose, for example) in the polymer composition mixture for 30 minutes; and a third step includes removing the inert support 10 from the polymer composition mixture and drying the inert support 10, optionally at an elevated temperature, for a period (e.g., overnight).

As a second example of deposition of a polymer composition onto inert support 10, a first step includes mixing the polymer composition in isododecane at any concentration, from 0-100%, preferably 20-100%, to produce a polymer composition mixture; a second step includes submerging the patch (e.g., inert support 10, which can comprise cellulose, for example) in the polymer composition mixture for 30 minutes; and a third step includes removing the inert support 10 from the polymer composition mixture and drying the inert support 10, optionally at an elevated temperature, for a period (e.g., overnight).

### Kits and Methods

In other aspects, the disclosure provides kits that comprise one or more patches of the disclosure. Example embodiments of kits include a pollution detection patch, optionally in combination with instructional materials, for example. The kits can be provided and/or used as standalone units, or can be combined with other products or kits for combination offerings. An example combination kit includes one or more pollution detection patches and one or more skincare products, for example, for mitigation of adverse skin healthcare conditions that could result due to exposure to PM pollution, for example.

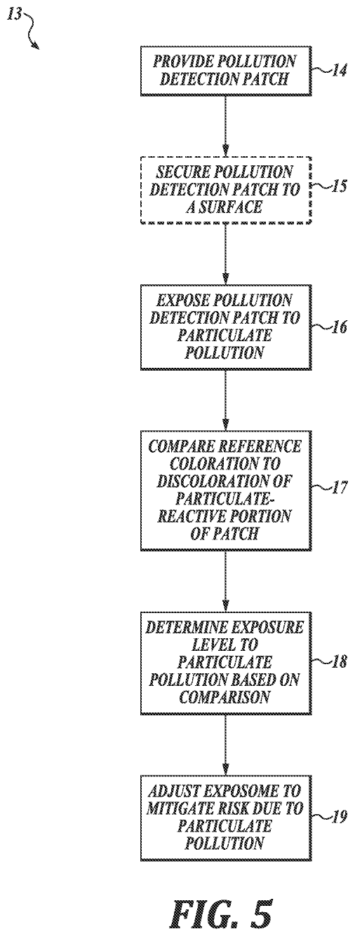

In other aspects, the disclosure provides methods for managing or mitigating risk due to exposure to PM, optionally in combination with one or more other pollutants or environmental stressors. As shown at FIG. 5, an example method 13 for mitigating risk due to exposure to particulate matter can use an example pollution detection patch according to the disclosure. In the shown embodiment, method 13 for mitigating risk comprises step 14: provide pollution detection patch, wherein a patch is provided to a person, group of people, or an organization. At step 15, which can be optional, the pollution detection patch can be secured to a surface. At step 16, the pollution detection patch is exposed to particulate pollution, resulting in discoloration of the polymer of the patch, as described elsewhere herein. At step 17, a reference is compared to discoloration of the polymer, i.e., the particulate-reactive portion of the patch, for a comparison. At step 18, level of exposure to PM is determined based on the comparison. At step 19, the exposome—the range of potentially harmful environmental exposures to which a person or group of individuals is exposed (including PM exposure)—is adjusted such that the person or group of individuals has a lower risk of adverse health conditions due to their exposome. Example adjustments can include altering a route of travel or transport, staying indoors for a period of time, wearing a respiratory mask, applying a cosmetic composition to the skin or other body part, taking medication, or another action.

### Non-Limiting Embodiments

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.

Embodiment 1. An article for determination of exposure to airborne particulate matter, the article comprising: a polymer configured to adsorb airborne particulates thereon, wherein adsorption of airborne particulates to the polymer causes the polymer to become a discolored polymer; and a discoloration reference configured for an optical comparison with the discolored polymer, wherein the optical comparison enables determination of whether the article has airborne particulate matter exposure.

Embodiment 2. The article of any other Embodiment, wherein the discoloration reference optically corresponds to the discolored polymer, such that a visual appearance of the discoloration reference at least partially matches a visual appearance of the discolored polymer for determination of whether the article has airborne particulate matter exposure.

Embodiment 3. The article of any other Embodiment, wherein the polymer is hydrophobic.

Embodiment 4. The article of any other Embodiment, wherein the discoloration reference is movably attached to a portion of the article that comprises the polymer on at least a portion thereof, such that movement of the discoloration reference closer to or relative to the polymer facilitates the optical comparison.

Embodiment 5. The article of any other Embodiment, wherein the discoloration reference is rotatably attached to a portion of the article that comprises the polymer on at least a portion thereof, such that rotational movement of the discoloration reference closer to or relative to the polymer facilitates the optical comparison.

Embodiment 6. The article of any other Embodiment, wherein the discoloration reference comprises an aperture thereon, such that a portion of a surface positioned underneath the aperture appears adjacent to the discoloration reference for the optical comparison between the discoloration reference and the discolored polymer.

Embodiment 7. The article of any other Embodiment, wherein the article comprises a plurality of discoloration references along a gradient and each discoloration reference corresponds to a degree of discoloration of the discolored polymer.

Embodiment 8. The article of any other Embodiment, wherein the article further comprises an attachment portion configured for attachment of the article to a surface.

Embodiment 9. The article of any other Embodiment, wherein the attachment portion is a lower layer of the article, the polymer is at least part of an intermediate layer of the article, and the discoloration reference is an upper layer of the article.

Embodiment 10. An article for measurement of exposure to airborne particulate matter, the article comprising: a polymer configured to adsorb airborne particulates thereon, wherein adsorption of airborne particulates to the polymer causes the polymer to become a discolored polymer that is discolored with a degree of discoloration; and a plurality of discoloration references along a gradient configured for an optical comparison with the discolored polymer, wherein the optical comparison correlates a particular discoloration reference of the gradient with the degree of discoloration of the discolored polymer for measurement of exposure of the article to airborne particulate matter.

Embodiment 11. The article of any other Embodiment, wherein each discoloration reference corresponds to a level of exposure to airborne particulate matter that is based at least in part on an airborne concentration of particulate matter in an environment.

Embodiment 12. The article of any other Embodiment, wherein the plurality of discoloration references are arranged adjacent to each other in an arrangement with the gradient increasing along the arrangement.

Embodiment 13. The article of any other Embodiment, wherein the article is circular, the arrangement of the plurality of discoloration references is a semi-circle, and each discoloration reference is a circle sector of the semi-circle.

Embodiment 14. The article of any other Embodiment, wherein each discoloration reference comprises an aperture thereon, such that a portion of a surface positioned underneath the aperture appears adjacent to the particular discoloration reference for the optical comparison between the particular discoloration reference and the degree of discoloration of the discolored polymer.

Embodiment 15. The article of any other Embodiment, wherein the semi-circle arrangement of the plurality of discoloration references is rotatably attached to a portion of the article that comprises the polymer on at least a portion thereof, such that rotational movement of the semi-circle arrangement of the plurality of discoloration references closer to or relative to the polymer facilitates the optical comparison.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. An article for determination of exposure to airborne particulate matter, the article comprising:
a polymer configured to adsorb airborne particulates thereon, wherein adsorption of airborne particulates to the polymer causes the polymer to become a discolored polymer; and
a discoloration reference configured for an optical comparison with the discolored polymer, wherein the optical comparison enables determination of whether the article has airborne particulate matter exposure.

2. The article of claim 1, wherein the discoloration reference optically corresponds to the discolored polymer, such that a visual appearance of the discoloration reference at least partially matches a visual appearance of the discolored polymer for determination of whether the article has airborne particulate matter exposure.

3. The article of claim 1, wherein the polymer is hydrophobic.

4. The article of claim 1, wherein the discoloration reference is movably attached to a portion of the article that comprises the polymer on at least a portion thereof, such that movement of the discoloration reference closer to or relative to the polymer facilitates the optical comparison.

5. The article of claim 1, wherein the discoloration reference is rotatably attached to a portion of the article that comprises the polymer on at least a portion thereof, such that rotational movement of the discoloration reference closer to or relative to the polymer facilitates the optical comparison.

6. The article of claim 1, wherein the discoloration reference comprises an aperture thereon, such that a portion of a surface positioned underneath the aperture appears adjacent to the discoloration reference for the optical comparison between the discoloration reference and the discolored polymer.

7. The article of claim 1, wherein the article comprises a plurality of discoloration references along a gradient and each discoloration reference corresponds to a degree of discoloration of the discolored polymer.

8. The article of claim 1, wherein the article further comprises an attachment portion configured for attachment of the article to a surface.

9. The article of claim 8, wherein the attachment portion is a lower layer of the article, the polymer is at least part of an intermediate layer of the article, and the discoloration reference is an upper layer of the article.

10. An article for measurement of exposure to airborne particulate matter, the article comprising:
a polymer configured to adsorb airborne particulates thereon, wherein adsorption of airborne particulates to the polymer causes the polymer to become a discolored polymer that is discolored with a degree of discoloration; and
a plurality of discoloration references along a gradient configured for an optical comparison with the discolored polymer, wherein the optical comparison correlates a particular discoloration reference of the gradient with the degree of discoloration of the discolored polymer for measurement of exposure of the article to airborne particulate matter.

11. The article of claim 10, wherein each discoloration reference corresponds to a level of exposure to airborne particulate matter that is based at least in part on an airborne concentration of particulate matter in an environment.

12. The article of claim 10, wherein the plurality of discoloration references are arranged adjacent to each other in an arrangement with the gradient increasing along the arrangement.

13. The article of claim 12, wherein the article is circular, the arrangement of the plurality of discoloration references is a semi-circle, and each discoloration reference is a circle sector of the semi-circle.

14. The article of claim 13, wherein each discoloration reference comprises an aperture thereon, such that a portion of a surface positioned underneath the aperture appears adjacent to the particular discoloration reference for the optical comparison between the particular discoloration reference and the degree of discoloration of the discolored polymer.

15. The article of claim 14, wherein the semi-circle arrangement of the plurality of discoloration references is rotatably attached to a portion of the article that comprises the polymer on at least a portion thereof, such that rotational movement of the semi-circle arrangement of the plurality of discoloration references closer to or relative to the polymer facilitates the optical comparison.
